(19) United States
(12) Patent Application Publication
(10) Pub. No.: US 2003/0048794 A1
(43) Pub. Date: Mar. 13, 2003

(54) Interconnecting device having radio communication function, and interconnecting system

(76) Inventors: Kazuhiko Sato, Tokyo (JP); Takatsugu Nishi, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/190,885

(22) Filed: Jul. 3, 2002

(30) Foreign Application Priority Data
Sep. 11, 2001 (JP) 2001-275727

(51) Int. Cl. H04L 12/28

(52) U.S. Cl. 370/401

(57) ABSTRACT

An interconnecting device configured to be connected to a network and a plurality of network devices. The interconnecting device comprises a wireless communication portion for wireless communication with the network devices, and a control portion for routing a packet among the network devices via the wireless communication portion. The wireless communication portion may comprise a bluetooth compatible module.

### BACKGROUND OF THE INVENTION

1. Field of the Invention

The present invention relates generally to network systems and devices, and to an interconnecting device and system. More portionicularly, this invention relates to systems and devices operating in wireless networks, such as wireless local area networks (LANs) and wireless wide area networks (WANs).

2. Description of the Related Art

Along with the recent widespread of LANs and WANs, a large number of network devices, such as personal computers (“PCs” hereinafter), hubs, switches, and routers (hubs etc. are often called “agents”) have been connected to a network and its subnet(s) for frequent information sharing and communications.

Among such network devices are interconnecting devices, such as a hub, a switch and a router, which connect to a LAN or a WAN. In portionicular, the routers take the lead in terms of versatility and are compatible with various network interfaces, such as LAN media including Ethernet, Token Ring, and Fiber Distributed Data Interface (FDDI), and WAN media including High-Level Data Link Control (HDLC) via a physical interface such as V.35, X.21, Basic Rate Interface (BRI), Frame Relay, X.25, ISDN, and ATM.

Such a network system uses various types of network configurations, one type of which uses a main router to connect a plurality of network devices in a head office to one another, and to a plurality of network devices in various branches via the main router and a public network connected to the main router, such as the analog telephone network and ISDN. Typically, wire media, such as a LAN cable, are used to connect these network devices to the router, while a wire medium, such as an ISDN cable, is used to connect the router to the public network.

Depending on installation location, it may be difficult to freely and easily build a network using a wire medium. There are instances where it is desirable to connect a group's head office network to another, geographically distant network that is built, for example, in a branch office, a site of construction, a building site, and/or an exhibition hall for a wide variety of information exchanges. As described above, a connection between the other network and the head office's network requires a wire line for connecting the other networks to the public network, undesirably resulting in arduous and expensive installation work.

It is economically undesirable to install the wire line for a temporarily built network in sites such as a construction site, a building site, or an exhibition hall. In addition, an office environment may also have an unsuitable environment to build a network, such as a conference room. Moreover, typical wire transmission media for connecting a router to network devices have many potential drawbacks, e.g., an unattractive appearance as the number of network devices increases, the requirement of an additional or extended LAN cable as a network-device layout changes, and vulnerability to short-circuiting in a cable.

Thus, there is a need in the technology to have the ability to install such networks freely and easily, without the inconvenience of a wired medium and associated physical drawbacks.

### SUMMARY OF THE INVENTION

Accordingly, it is an object of the present invention to provide an interconnecting device and system for freely and easily building a network irrespective of a condition of an installation location.

In order to achieve this object, an interconnecting device of one aspect of the present invention for connection to a network and one or more network devices comprises a wireless communication portion and a control portion for routing a packet among the network devices via the wireless communication portion. The wireless communication device may comprise a bluetooth module. As is commonly known in the art, bluetooth technology involves short-range radio aimed at simplifying communications among network devices and between devices and the Internet. The Bluetooth 1.0 specification consists of two documents: the Foundation Core, which provides design specifications, and the Foundation Profile, which provides interoperability guidelines. The Bluetooth specification 1.0 (and later revisions that may be available as of the filing date of this application) is hereby incorporated in its entirety by reference. This interconnecting device provides wireless communication capabilities and does not require arduous installation work, such as installing a wire cable, as in the conventional interconnecting device that uses a wire cable. Thereby, the interconnecting device may easily build a network irrespective of conditions of an installation location and time. The wireless communication portion may comprise an Infrared Data Association (IrDA) module. The wireless communication portion may provide wireless communications between the interconnecting device and the network device and/or between the interconnecting device and an external device or network.

The interconnecting device may further comprise a housing for accommodating the wireless communication device and the control portion. The wireless communication portion may comprise an expansion module for expanding a function of the interconnecting device, wherein the housing comprises an expansion slot and the expansion medium may be removably inserted into the expansion slot in the housing. In one embodiment, the expansion medium is inserted into the slot in the housing so as to provide the interconnecting device with wireless communication capabilities. The expansion medium may be used for wireless communication between the interconnecting device and the network device and/or between the interconnecting device and an external network. For example, the expansion medium may be a communication card including a bluetooth module and/or a Personal Handy-phone System (PHS) card. The expansion slot may be a PC card slot. In the event both a bluetooth module card and a PHS card are used, the housing is provided with two slots. When a PHS card is inserted into the slot, for instance, the interconnecting device may receive a packet from a public network, such as an analog telephone network and ISDN, through a PHS relay station, and send a packet to the public network through the PHS relay station.

The interconnecting device may further comprise a wire communication portion that provides a wire communication with at least one of the network devices, and a storage portion that stores a routing table for correlating each network device with one of the wireless and wire communication portions, wherein the control portion refers to the storage portion when attempting to route the packet. This interconnecting device is compatible with the wire and wireless communications, and the control portion uses the storage portion to determine a suitable interface when attempting to route a packet.

An interconnecting device according to another aspect of the present invention is configured for connection to a network and one or more network devices, and comprises a control portion and a housing. The control portion may be configured to route a packet among the network devices, and the housing may accommodate a wireless communication portion and a control portion, wherein the housing has a slot through which an expansion medium for expanding a function of the interconnecting portion may be removably inserted. Such an interconnecting device may expand its function by receiving an expansion medium inserted into the slot in the housing.

An interconnecting system according to another aspect of the present invention comprises a plurality of network devices, and an interconnecting device for connecting the network devices to a network. The interconnecting device comprises a wireless communication portion, , and a control portion for routing a packet among network devices via the wireless communication portion. The wireless communication portion may comprise a bluetooth module. The network device may be a router, or a portable electronic device, such as a notebook PC, a Personal Digital Assistant (PDA), a cellular phone, a PHS, or a digital camera. When the network device comprises a router, such a router may constitute a subnet of the interconnecting system as a network.

An interconnecting system according to another aspect of the present invention comprises a first network comprising a plurality of network devices, a second network connected to the first network via a third network, and an interconnecting device for connecting the network devices to the first network. The interconnecting device comprises a wireless communication portion, wherein the wireless communication portion may be a bluetooth module, and a control portion for routing a packet among the network devices via the wireless communication portion. The second network may comprise a plurality of other network devices, and another interconnecting device wire-connected to the other network devices and the public line, configured to route a packet among the other network devices. In this case, the second network may be built, for example, in a head office, while the first network is built, for example, in a branch office or a temporary location, such as a site of construction, a building site, or an exhibition hall. Then, the other interconnecting device in the second network would be fixed, whereas the interconnecting device in the first network would be mobile. The third network is, for example, a public network.

An additional aspect of the invention comprises a method of connecting a plurality of network devices to a network with an interconnecting device, wherein the interconnecting device comprises a wireless communication portion, and a wire communication portion that provides a wire communication with at least one of the network devices. The method comprises creating a routing table for correlating each network device with one of the wireless and wire communication portions, and routing a packet to the network devices using one of the wireless and wire communication portions that has been defined in the routing table. This interconnecting method creates the routing table and assists in routing a packet by specifying an interface selected from the wireless and wire communication portions. A Media Access Control (MAC) address, an Internet Protocol (IP) address, etc. may be used for device identification of each network device.

The network devices may comprise first and second network devices, wherein the method may further comprise performing a predefined process including modulation and demodulation for a packet from a first network device to a second network device, when the interconnecting device uses a different one of the wireless and wire communication portions for each of the first and second network devices. For example, suppose that the interconnecting device uses a bluetooth module to communicate with the first network device and uses a wire cable to communicate with the second network device. When the first network device sends a specific packet to the second network device, the modulation or demodulation assists the second network device in understanding the packet through the interconnecting device. Similarly, the wireless communication portion may comprise plural types of wireless communication means, and creating the routing table may comprise identifying a type of wireless communication means. In addition, the network devices may comprise first and second network devices, wherein the method may further comprise the step of performing a process including modulation and demodulation for a packet from a first network device to a second network device, when the interconnecting device uses a different type of wireless communication means for each of the first and second network devices.

Other objects and further features of the present invention will become readily apparent from the following description of preferred embodiments with reference to accompanying drawings.

### BRIEF DESCRIPTION OF THE DRAWINGS

FIG. 1 is a block diagram of an interconnecting device according to the present invention.

FIG. 2A is a front view of the interconnecting device of FIG. 1.

FIG. 2B is a rear view of the interconnecting device of FIG. 1.

FIG. 3 is an exemplary illustration of a routing table.

FIG. 4 is a block diagram of an interconnecting system implementing the interconnecting device of FIG. 1.

FIG. 5 is a block diagram of a network device for use with the interconnecting system of FIG. 4.

FIG. 6 is a flowchart illustrating a method of operation of the interconnecting system of FIG. 4.

FIG. 7 is a block diagram of an additional embodiment of the interconnecting device of FIG. 1.

FIGS. 8A-8C are block diagrams illustrating a routing process in the interconnecting system shown in FIG. 4.

### DETAILED DESCRIPTION OF CERTAIN EMBODIMENTS

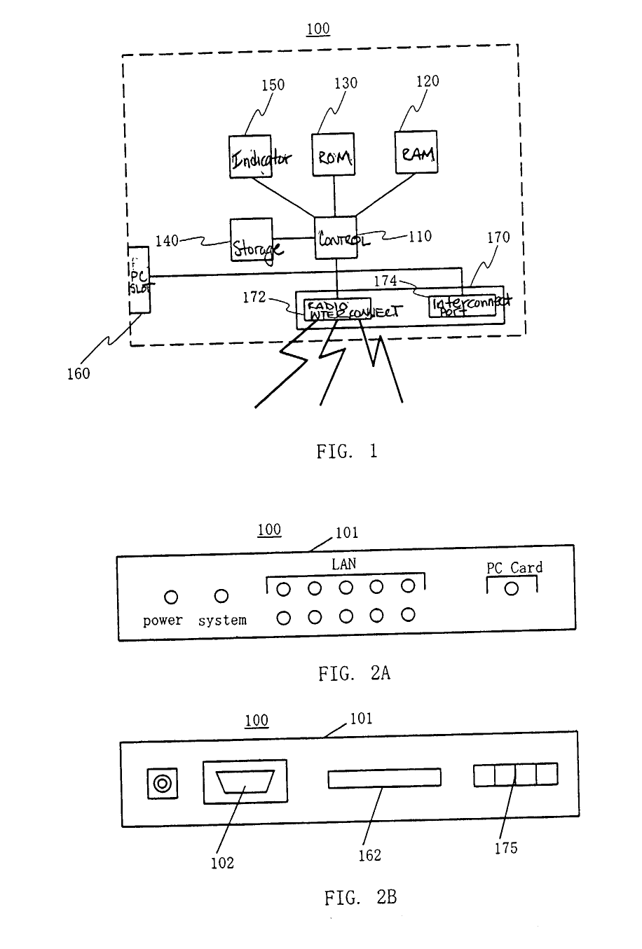

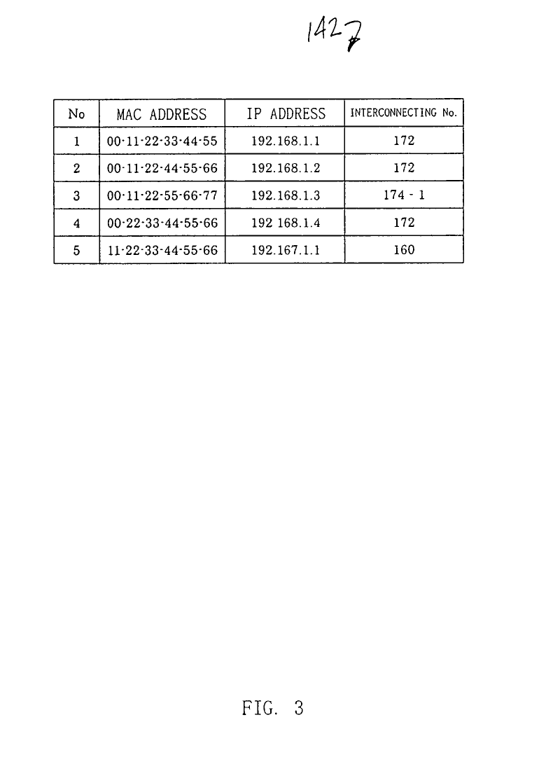

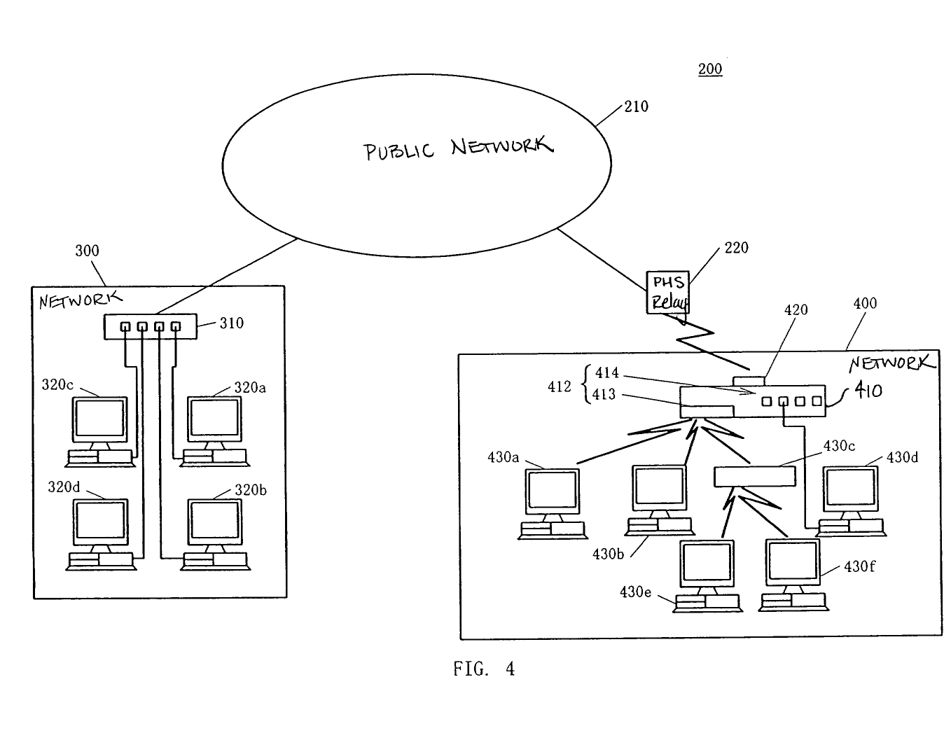

A description will now be given of an interconnecting device 100, and an interconnecting system 200 implementing the interconnecting device 100, with reference to the accompanied drawings. FIG. 1 is a block diagram of the interconnecting device 100. FIG. 2A is a front view illustration of the interconnecting device 100 shown in FIG. 1. FIG. 2B is a rear view illustration of the interconnecting device 100 shown in FIG. 1. FIG. 3 is an example of a routing table. FIG. 4 is a block diagram of an interconnecting system 200 implementing the interconnecting device 100 shown in FIG. 1.

The interconnecting device 100 interconnects network devices connected to it, configures a network (or its subnet of the network), and deliver a packet among the network devices (or performs a routing process). The interconnecting device 100 may communicate with another interconnecting device, and connect LANs or a LAN to a WAN, for the routing process.

As shown in FIG. 1, the interconnecting device (“router” hereinafter) 100 comprises a control portion 110, a RAM 120, a ROM 130, a storage portion 140, an indicator portion 150, a PC card slot 160, and an interconnecting portion 170. Each component may be configured to receive data. In FIGS. 2A and 2B, the router 100 further comprises a housing 101 that defines the device's appearance, and accommodates, in the housing 101, the control portion 110, RAM 120, ROM 130, storage portion 150, and interconnecting portion 170's wireless interconnecting portion 172, which will be described later. The indicator portion 150 is located at the front of the housing 101, while an opening 162 of the PC card slot 160 and openings 175 of interconnecting ports 174, described below, in the interconnecting portion 170 are formed at the rear of the housing 101.

The control portion 110 may be a processor such as a CPU or an MPU, and may be configured to control each component in the router 100. The router 100 may be connected to a host (not shown) through a console port 102 etc., and the control portion 110 may communicate with the host. In one embodiment, the control portion 110 performs a routing process for a packet to a network device through the interconnecting portion 170, based on a routing table 142 stored in the storage portion 140. The control portion 110 receives a packet addressed to the router 100, stores it in the storage portion 140 or performs a predefined process based on the packet. Moreover, the control portion 110 performs a routing process between the LAN and WAN via a communication card inserted into the PC card slot 160, which will be described later. More specifically, the control portion 110 transmits a packet to a network device in a LAN or WAN via the interconnecting portion 170 or the communication card.

Although not described in detail, the control portion 110 may set up communication parameters for network devices. In other words, the interconnecting device 100 may serve as a Dynamic Host Configuration Protocol (DHCP) server for a network device as portion of a LAN.

The control portion 110 (or an administrator who has connected a PC etc. to the console port 102 shown in FIG. 1 and may communicate with the control portion 110 using the PC etc.) may control a structure, performance, security and billing. For example, the control portion 110 may use a Simple Network Management Protocol (SNMP) to control the network devices of the LAN.

The structure control may monitor statuses of the network devices of the LAN and control their operations. A firmware version for each network device may also be identifiable. Thereby, the control portion 110 or network administrator may recognize the most current network structure. The performance control may measure performance of each device in the network. In the performance control, the control portion 110 or network administrator may monitor traffic of each device and thus network performance, such as whether an improper packet is flowing and whether there is a performance error. The security control may restrict use of the resource (information or equipment) in the network so as to maintain appropriate use of the resource. The control portion 110 or network administrator may discover unauthorized use and prevent unauthorized users from an intrusion into a network by regularly investigating users' access logs. The billing control may record a status of use of the resource in the network for each user. The control portion 110 or network administrator may recognize the use ratio of the network resource for each user to warn a user of improper use of the resource, or to use the use ratio as a material to provide better services.

The RAM 120 may temporarily store data to be read from the ROM 130 and storage portion 140, data to be written in the storage portion 140, and the like. In one embodiment, the RAM 120 temporarily stores data to be read from the routing table 142 and data to be stored in the routing table 142.

The ROM 130 stores various kinds of software and firmware for operations of the control portion 110, and other types of software. In one embodiment, the ROM 130 stores a program for executing the routing process, which will be described with respect to the method of operation.

In one embodiment, the storage portion 140 stores a network address on the WAN and the routing table 142 shown in FIG. 3. Alternatively, the ROM 130 may store the network address on the WAN side and the routing table 142. Here, FIG. 3 illustrates an exemplary routing table 142.

The routing table 142 comprises Media Access Control (MAC) addresses indicative of a device's ID, IP addresses as one communication parameter, and interconnecting numbers. The routing table 142 may further comprise subnet masks and next hops.

The MAC address is an address for identifying an information device connected to a LAN and a hardware address of the interconnecting device located on a communication channel to reach an IP address.

The IP address is a period separated four-block address, each block ranging 0-255 in decimal notation, and assigned to a computer connected to the TCP/IP network circumstance. The IP address is included in an IP header provided by the IP protocol in the network layer in the TCP/IP protocol.

The interconnecting number represents an interface through which the router 100 sends a packet. In FIG. 3, the interconnecting number represents the PC card slot 160, the wireless interconnecting portion 172 (directed to a bluetooth module), and interconnecting port 174's port numbers 1-4 in the interconnecting portion 170. When the system uses an additional type of wireless communication, such as IrDA, the routing table 142 identifies the type of communication.

The subnet mask is a bit pattern for separating the host address portion of the IP address into a subnet address and a host address. The next hop includes information on a router to which the router 100 is connected.

The indicator portion 150 indicates a status of the router 100, a connection status of each network device connected to the router 100, and a PC card's insertion status at the PC card slot 160. The indicator portion 150 may include, for example, LEDs, which are illustrated as circles in FIG. 2A. The indicator portion 150 indicates these statuses with lights on and off. For example, the indicator portion 150 illuminates to indicate such a status that the router 100 is powered on, that a network device is connected to a LAN cable connected to the interconnecting port 174 in the interconnecting portion 170, that the interconnecting portion 170 communicates with the network device, that a PC card is inserted into the PC card slot 160, and the like. Instead of the LED, an LCD and any other indicator structure may be used for the indicator portion 150 so as to achieve the above function. For example, an LED lighting mechanism may employ a method for comparing a preset slice level with the voltage in each of the interconnecting portion's interconnecting port 174, a contact-type sensor, an infrared sensor, etc. provided in the PC card slot 160.

The PC card slot 160 is a slot through which a PC card may be removably inserted. The PC card slot 160 is configured as a space extending from an opening 162 formed at the rear surface of the housing 101 of the router 100 and having a shape corresponding to that of the PC card. The PC card slot 160 has a connector (not shown) to be connected to the PC card so as to connect the PC card to the control portion 110. Here, the “PC card” is a card-shaped peripheral standard for use with a PC, cooperatively stimulated by Personal Computer Memory Card International Association (PCMCIA) and Japan Electronic Industry Development Association (JEIDA). The PC card has a size of 85.6 mm×54 mm, and may be classified into three types, i.e., types 1-3 depending upon its thickness (i.e., 3.3 mm, 5.0 mm, and 10.5 mm), or four types, further including a Thick Type with a thickness of 8.0 mm.

The router 100 in this embodiment may be connected to the WAN through a PHS relay station and public network when a PHS card is inserted into the PC card slot 160. Moreover, the PC card inserted into the PC card slot 160 may provide a wireless connection between the router 100 and the public network, thereby connecting one network to another network without requiring a wire cable connection.

Here, the PHS simplifies equipment and a communication specification, and may digitize an analog cordless phone. The PHS may realize more reasonable communication circumstances, since one base station in the PHS has a narrow coverage area, a frequency bandwidth for each terminal is wider than that of a cellular phone, and a data communication speed may be much faster than a cellular phone. The PHS is advantageous in that it is relatively easy and inexpensive to create a base station at various locations, for example, even in an underground mall or a subway station.

The PC card applicable to the present invention is not limited to a PHS communication card, and any card which achieves a wireless communication via the public network, such a PC card or a mobile card which use a cellular phone to connect to the public network, or electric radiation network via the cellular phone relay station. The router 100 doe not necessarily use the opening 162 of a size of PC card, but may use a Compact Flash (CF) slot and any other slot corresponding to a wireless communication medium (a communication medium having a function similar to that of the PHS card etc.). Thus, the card connectable to the interconnecting device 100 is not limited to the PC card, and may use various communication cards including the above CF card. This embodiment uses the detachable communication card, such as a PHS card, relative to the router 100, but the present invention does not exclude an undetachable configuration of a device having functions similar to these cards or communication media.

The interconnecting portion 170 interconnects network devices on the LAN, and includes the wireless interconnecting portion 172 and interconnecting port 174.

The wireless interconnecting portion 172 is exemplarily implemented as a bluetooth module, and comprises a radio signal transmitter/receiver and a processor. The wireless interconnecting portion 172 receives a packet from a network device at the LAN side, converts the packet into a radio signal using the bluetooth module, and transmits the converted signal to another network device. The bluetooth module applies the bluetooth communication standard, which is a spread spectrum type packet communication system, and is the short-range radio communication standard for connecting PCs, peripherals, cellular phones, and information terminals with one another. The bluetooth module is provided with a synchronous transmission channel for voice transmissions and an asynchronous transmission channel for data transmissions. The bluetooth communication standard currently has a connectable range of about 10 m, which is extendable up to 100 m using an additional amplifier.

The radio signal transmitter/receiver transmits and receives radio signals converted by the bluetooth module. The radio signal transmitter may, for example, the comprise a D/A converter, a low-pass filter, a FM modulator, a burst modulator, while the receiver may comprise an IF filter, a FM demodulator, a threshold detector/clock discovery, and a frequency hopping controller.

The processor communicates with the control portion 110, and controls each portion in the bluetooth module. More specifically, the processor is implemented, for instance, as a DSP (digital signal processor) for controlling a packet, an error correction, security, data randomization, etc.

Instead of the bluetooth module, the wireless interconnecting portion 172 may use other wireless communication means known in the art, such as Infrared Data Association (IrDA), which is an infrared communication standard including IrDA 1.0 with 115.2 kbps and IrDA 1.1 with 4.0 Mbps.

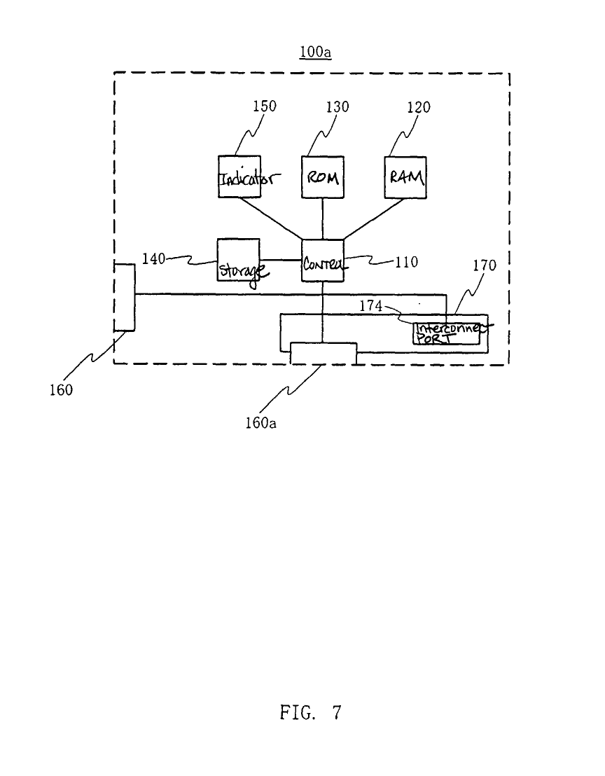

The wireless interconnecting portion 172 is not necessarily housed in the housing 101 of the router 100, but may be implemented as a communication card compatible with the PC card slot 160. In this embodiment, a communication card that serves as the wireless interconnecting portion 172 may be exchangeable with the PHS card. Alternatively, the PC card slot 160a may be provided as shown in FIG. 7, to enable two cards to be inserted, i.e., a PHS card and a communication card (including, for example, a bluetooth module). Here, FIG. 7 is a block diagram of an interconnecting device 100a as an alternate embodiment of the interconnecting device 100.

The interconnecting port 174 is a communication port for connection to a network device through a wire cable etc. The interconnecting port 174 may be a connection port corresponding to an 8-pin modular jack for a network cable, such as a 10Base-T and 100Base-T. There are four interconnecting ports 174 in this embodiment. Since the router 100 uses the wireless interconnecting portion 172 to communicate with network devices on the LAN, the interconnecting port 174 may be omitted. The interconnecting port 174 may advantageously allow the router 100 of this embodiment to be connected to a network device that cannot communicate with the bluetooth module.

Thus, the router enables a network device to be connected to such a public network for a connection to the Internet and a WAN when a PHS card or another communication card is inserted into the PC card slot 160. Since the PHS card may wirelessly communicate with the public network, a LAN may be built at any location (within a communication range of a PHS relay station). The wireless LAN may be built when the bluetooth is used for communications with network devices on the LAN, thereby constructing a LAN independent of a condition of an installation location.

A description will now be given of an operation of the router 100 in the interconnecting system 200, and details of the interconnecting system 200, with reference to FIG. 4. The interconnecting system 200 is implemented for a WAN connected to a network (LAN) 300 and a network (LAN) 400. More specifically, the LAN 300 is connected to the public network 210 with a wire cable, while the LAN 400 is wirelessly connected to the public network 210 through the PHS relay station 220. For example, the LAN 300 is implemented in a company's head office, while the LAN 400 is implemented in a company's branch office, a construction site, a building site, an exhibition hall, etc. Of course, the LAN 300 may be implemented as a wireless network similar to the LAN 400. Although FIG. 4 shows two networks, i.e., the networks 300 and 400, the present invention is not limited to this network configuration and the WAN may comprise a plurality of networks.

The public network 210 comprises the analog telephone network, the ISDN, etc. The PHS relay station 220 is a station that meets PHS data communication standard defined by PHS Internet Access Forum (PITF) and relays data between the public network 210 and a device that communicates with the PHS relay station 220. The public network 210 and PHS relay network 220 may use any technology known in the art, and a detailed description thereof will be omitted.

The network 300 exemplarily comprises one router 310 and a plurality of network devices 320. FIG. 4 exemplarily shows four network devices 320a-320d, and the reference numeral 320 generalizes 320a-320d in this specification unless otherwise specified.

The interconnecting device 310 is a device for connecting the network devices 320 to the networks 300 and 400, and has interconnecting ports connected to the network device 320. The interconnecting device 310 may have a communication port (not shown), connected to a wire cable through which the interconnecting device 310 is connected to the public network 210. The communication port (not shown) may be a USB port or IEEE 1394 port for providing connections to the Internet (as necessary, via an Internet Service Provider (ISP)) via a modem, or a terminal adapter (“TA”) through the public telephone network, ISDN, or various types of dedicated lines. The interconnecting device 100 may also be applied to the interconnecting device 310, and it may use a network system similar to the network 400, which will be described later.

The network device 320 is a network device connected to the interconnecting device 310, and may be a network device such as a hub, a switch, a router, any other concentrator, a repeater, a bridge, a gateway device, a PC, or a wireless interconnecting device (e.g., an access point as a interconnecting device for wireless LAN).

The network 400 comprises an interconnecting device 410, a PHS communication card 420, and a plurality of network devices 430. FIG. 4 exemplarily shows six network devices 430a-430f, and the reference numeral 430 generalizes 430a-430f in this specification unless otherwise specified. Such a network configuration is for exemplary purposes only, and does not restrict the present invention.

The interconnecting device 410 is a device for connecting the network devices 430 to the networks 400 and 300, and has an interconnecting portion 412 connected to the network device 430. The router 100 is applied to the interconnecting device 410, and FIG. 4 shows a wireless interconnecting portion 413 and interconnecting ports 414. When a PHS card 420 is inserted into a PC card slot (not shown in FIG. 4 but shown in FIG. 1), the interconnecting device 410 becomes connectable to the public network 210 through the PHS card 420 and PHS relay station 220. Since the interconnecting device 410 has a similar structure to the interconnecting device 100, a detailed description thereof will be omitted.

The PHS card 420 is an expansion card corresponding to a PC card having a PHS communication function. The PHS card 420 may use any technology known in the art, and a detailed description will be omitted. The PHS card may be, for example, a wireless communication device capable of communicating with the PHS relay station 220, a converter portion for performing A/D and D/A conversions, a processor for modulating and demodulating digital data, or a dial-up device for providing a dial-up connection. Such a structure enables the PHS card 420 to transmit a packet with the predetermined carrier frequency.

The network device 430 is connected to the interconnecting device 430, and may be a device such as a hub, a switch, a router, any other concentrator, a repeater, a bridge, a gateway device, a PC (e.g., a notebook PC), a wireless interconnecting device (e.g., an access point as a interconnecting device for wireless LAN), PDA, a PHS, a digital camera, or a cellular phone. Among network devices 430a-430f, this embodiment exemplarily implements network devices 430a, 430b, 430d-430f as PCs, and applies the interconnecting device 100 to the network device 430c so as to provide connections to network devices 430e and 430f.

Among the network devices 430, the network devices 430a-430c are connected to the network 400 via wireless communication with the interconnecting device 410, and the network devices 430e and 430f are connected to the network 400 via wireless communication with the network device 430c. The network device 430d is connected to the network 400 via a wire medium (for example, a LAN cable) and the interconnecting port 414 in the interconnecting device 400.

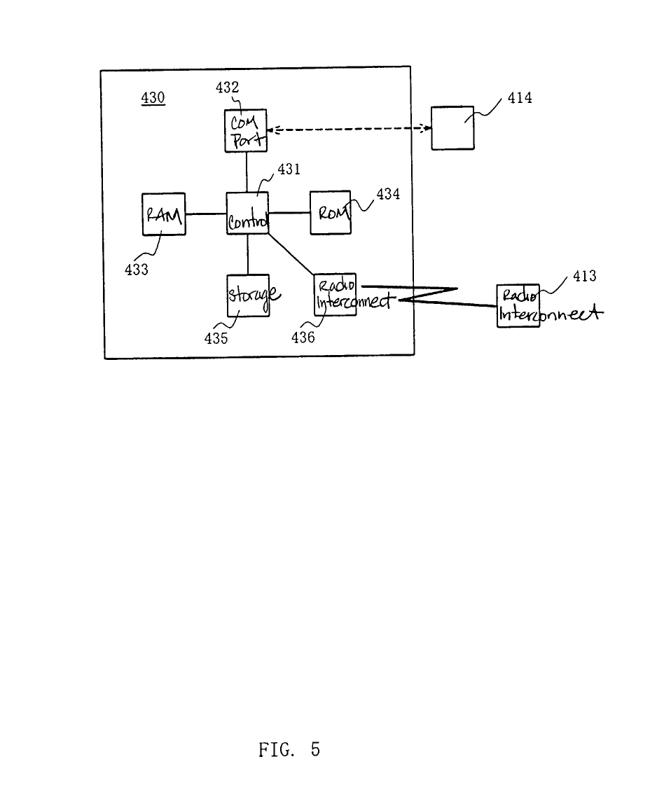

FIG. 5 is a schematic block diagram of the network device 430. Each of the network devices 430 (in portionicular, network devices 430a, 430b, and 430d-430f) comprises, as shown in FIG. 5, a control portion 431, a communication port 432, a RAM 433, a ROM 434, a storage portion 435, and a wireless interconnecting portion 436. FIG. 5 omits an input device and an output (e.g., display) device, associated with the network device 430, for simplicity purposes. Operating the input device, an operator of the network device 430 may enter various data in the storage portion 435, and download software in the RAM 433, ROM 434 and storage portion 435. The network device 430 may be connected to a host (not shown) to communicate with the host.

The control portion 431 may be a processor, such as a CPU or an MPU, and controls each portion in the network device 430.

The communication port 432 may be an LAN adapter connected to the interconnecting devices 40, a USB port or IEEE 1394 port for providing connections to the Internet (via an Internet Service Provider (ISP)) via a modem, or a terminal adapter (TA) through the public telephone network, ISDN, or various types of dedicated lines. In one embodiment communication port 432 is an interface connected to the interconnecting port 414 in the interconnecting device 420.

The RAM 433 temporarily stores data to be read from the ROM 434 and storage portion 435, data to be written in the storage portion 435, and the like. The ROM 434 stores various kinds of software and firmware for operations of the control portion 431, and other types of software. The storage portion 435 stores communication parameters and a configuration program. The configuration program is a program for receiving a communication parameter from the interconnecting device 410 for setting up the communication parameter on the network device 430, and may use any program known in the art.

The wireless interconnecting portion 436 is exemplarily implemented as a bluetooth module, and communicates with the wireless interconnecting portion 413 in the interconnecting device 410. Of course, as long as the wireless interconnecting portion 436 in the network device 430 may communicate with the wireless interconnecting portion 413 in the interconnecting device 410, its structure is not limited. When the wireless interconnecting portion 413 in the interconnecting device 410 use other wireless communication means, the wireless interconnecting portion 436 in the network device 430 should use corresponding wireless communication means accordingly.

The bluetooth module as the wireless interconnecting device 436 integrates a bluetooth communication protocol, and includes a radio signal transmitter/receiver and a processor.

The radio signal transmitter/receiver transmits and receives a converted radio signal or a radio signal to be converted by the bluetooth module. The radio signal transmitter/receiver may use any structure known in the art. For example, the transmitter may comprise a D/A converter, a low-pass filter, a FM modulator, and a burst modulator, while the receiver may comprise an IF filter, a FM demodulator, a threshold detector/clock discovery, and a frequency hopping controller.

The processor communicates with the control portion 431, and may control each portion in the bluetooth module 436. More specifically, the processor may be implemented, for instance, as a DSP (digital signal processor) for controlling a packet, an error correction, security, data randomization, etc.

Although the network device 430 in this embodiment includes both the communication port 432 and wireless interconnecting portion 436 as communication means, it is sufficient that the network device 430 has at least one of these communication means. For example, when the network device 430 includes only the wireless interconnecting portion 436, the network device 430 may wirelessly communicate with the interconnecting device 410 or 430c as the network devices 430a, 430b, 430e and 430f. Alternately, when the network device 430 includes only the communication port 432, the network device 430 may communicate with the interconnecting device 410 or 430c using a wired system as the network device 430d.

In one embodiment, the network device 430 includes the wireless interconnecting portion 436 as one of the components, but the network device 430 may use a removable card implemented as an expansion card for realizing functions of the wireless interconnecting portion 436.

The network device 430c among the network devices 430 utilizes the interconnecting device 100, and forms a subnet of the network 400. The network device 430c in this embodiment may communicate with the interconnecting device 410 via its wireless interconnecting portion (not shown). The network device 430c has a similar structure to that of the interconnecting device 100, and a detailed description thereof will be omitted. The network device 430c does not necessarily require but may include a PHS card 420 to be inserted into its PC card slot (not shown) to communicate, via the PHS relay station 220, with the networks 210, 300 and 400. Furthermore, the wireless interconnecting portion in the network device 430c may be implemented as a PC card compatible with the PC card slot. The network device 430c, having such a structure, would enable a PC card having functions of the wireless interconnecting portion to be inserted into the PC card slot or one of two PC card slots shown in FIG. 7, thereby exhibiting a similar operation.

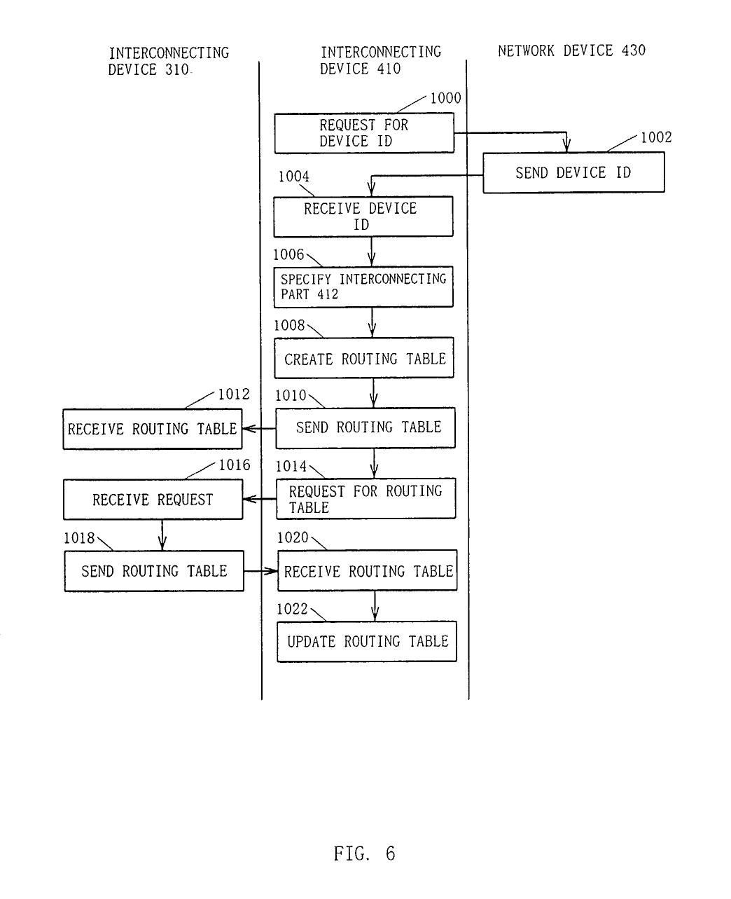

FIG. 6 is a flowchart illustrating a method of operation of the interconnecting system 200. Referring now to FIG. 6, in a step 1000, the interconnecting device 410 requests each network device 430 at the LAN side (under its control) for device ID of the network device 430. For example, the wireless interconnecting portion 413 in the interconnecting device 410 makes a request, under the control of a control portion (not shown), to the network device 430 to send the device ID. More specifically, the bluetooth module in the wireless interconnecting portion 413 performs a predetermined process including modulation for the request information and sends the resultant data. Alternately, when the interconnecting port 414 in the interconnecting device 410 compares the voltage in the interconnecting port 414 with a predefined slice level and detects power-on of the network device 430, a control portion (not shown) requests the network device 430 for its device ID.

In a step 1002, the network device 430 that has received the request sends its device ID (such as a MAC address). For example, when the network device 430a receives the request via the bluetooth module in the wireless interconnecting portion 436, the bluetooth module performs a predefined process comprising demodulation for the request signal, and sends it to the control portion 431. In response to this request, the control portion 431 sends the MAC address to the interconnecting device 410 in the reverse procedure. Alternately, when the network device 430d receives this request through the interconnecting port 432, the interconnecting port 432 sends the request to the control portion 431. Then, in response to this request, the control portion 431 sends the MAC address to the interconnecting port 414 of the interconnecting device 410.

In a step 1004, the interconnecting device 410, when receiving the MAC address from the wireless interconnecting portion 413 or the interconnecting port 414, stores the MAC address together with the information of the interconnecting portion 412 (i.e., whether it is the wireless interconnecting portion 413 or the interconnecting port 414) in the routing table in a storage portion (not shown) in a step 1006. As discussed with reference to FIG. 3, the control portion (not shown) of the interconnecting device 410 thus specifies one of the wireless interconnecting portion 413 and the interconnecting port 414 in the interconnecting portion 412, and stores the MAC address with this information in the routing table in a step 1008. Preferably, the interconnecting device 410 has previously set up the user ID and password for the network device 430, authenticates the user ID and the password as well as sending the MAC address, and determines whether it is the network device 430 that is authorized to be connected to the network 400. This prohibits an unauthorized person who attempts to enter the network.

When the interconnecting device 410 serves as a DHCP server, the interconnecting device 410 may provide the communicated network device 430 with a communication parameter including an IP address. For example, the interconnecting device 410 multicasts information including a communication parameter that has a one-to-one relationship with the MAC address, to a plurality of network devices 430 communicating with the wireless interconnecting portion 413, validates a unique communication parameter to each network device 430 having the proper MAC address. Alternately, the interconnecting device 410 specifies the interconnecting port 414 corresponding to the MAC address, and provides it with the communication parameter. Thereby, the interconnecting device 410 may store the communication parameter in the routing table.

When the network 400 has an independent DHCP server that has provided an IP address, the interconnecting device 410 may store a communication parameter including the IP address or plural pieces of information including the device ID and communication parameter(s), instead of the device ID (or MAC address in the above example).

In a step 1010, the interconnecting device 410 uses the PHS card 420 to send information on the routing table to the network address at the WAN side (or in the network 300) stored in the storage portion (not shown). For example, the control portion of the interconnecting device 410 communicates with the PHS card 420 and creates a dial-up connection with the interconnecting device 310, and sends information on the routing table to the network address.

In a step 1014, the interconnecting device 410 requests the interconnecting device 310 to send the routing table, which the interconnecting device 310 stores. In steps 1016 through 1018, the interconnecting device 310 sends the routing table in response to this request, and in steps 1020 through 1022, the interconnecting device 410 receives the routing table and stores it in the routing table in the storage portion. The interconnecting device 410 stores the interconnecting number representative of an interface as the PHS card 20 (or a PC card slot (not shown)), together with a communication parameter such as an IP address of the routing table received from the interconnecting device 310.

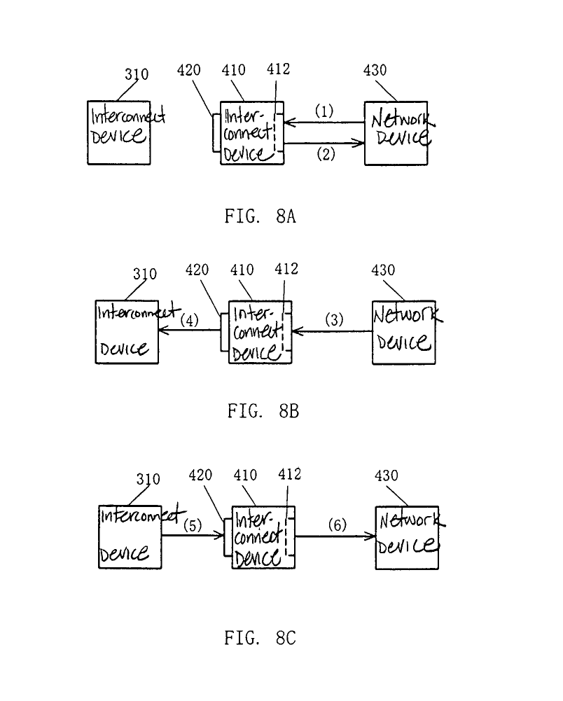

As a result of the above procedure, the interconnecting device 410 stores IP addresses of the network device 430 on the LAN and the network devices 320 on the WAN in the routing table. Thus, the interconnecting device 410 may send a packet to the network device 430 by referring to the routing table, as shown in FIG. 8. FIGS. 8A-8C are block diagrams illustrating a routing process for the interconnecting system 200.

More specifically, suppose that a packet is sent from one network device 430 to the interconnecting device 410 as shown by an arrow (1) in FIG. 8A. This packet is received via the interconnecting portion 412, and forwarded to the control portion (not shown) in the interconnecting device 410. The control portion then refers to an IP header and a routing table in this packet, and determines the interface for sending this packet. When the IP header indicates another network device 430 at the LAN side, the control portion in the interconnecting device 410 sends the packet to a target network device 430 as shown by an arrow (2) in FIG. 8A through the wireless interconnecting portion 413 or interconnecting port 414 in the interconnecting portion 412.

Next, suppose that a packet is supplied from the network device 430 to the interconnecting device 410 as shown by an arrow (3) in FIG. 8B. This packet is received through the interconnecting portion 412, and forwarded to the control portion (not shown) in the interconnecting device 410. The control portion then refers to an IP header and a routing table in this packet, and determines the interface for sending this packet. When the IP header indicates a network device 320 on the WAN, the control portion in the interconnecting device 410 sends, as shown in an arrow (4) in FIG. 8B, the packet to the interconnecting device 310 designating a target network device 320 (not shown) through the PC card 420 in the PC card slot.

Suppose that a packet is supplied from the network device 320 (not shown) to the interconnecting device 410 through the interconnecting device 310 as shown by an arrow (5) in FIG. 8C. This packet is received through the PHS card 420 in the PC card slot in the interconnecting portion 410, and forwarded to the control portion (not shown) in the interconnecting device 410. The control portion then refers to an IP header and a routing table in this packet, and determines the interface for sending this packet. When the IP header indicates the network device 430 on the LAN in the interconnecting device 410, the control portion in the interconnecting device 410 sends the packet to the target network device 430 as shown in an arrow (6) in FIG. 8C via the wireless interconnecting portion 413 or interconnecting port 414 in the interconnecting portion 412.

As discussed above, according to the interconnecting system 200 of the present invention, the interconnecting device 410 is configured to connect to the public network 210 through the PHS card 420. The interconnecting device 410 may wirelessly communicate with the public network 210, thereby eliminating arduous tasks such as installing cable in the conventional wire interconnecting system. The interconnecting system 200 easily provides an structure for building a network without being affected by restrictions from conditions of an installation location and work time. In addition, the wireless communication between the interconnecting device 410 and the network device 430 may eliminate cable wiring and facilitate network construction. The interconnecting system according to the invention may easily connect LAN(s) and WAN(s) even in such a location to which a wire LAN system is unsuitably applied, such as a site of construction, a building site, or an exhibition hall, thereby providing a convenient network environment.

Further, the present invention is not limited to the preferred embodiment, and various variations and modifications may be made without departing from the present invention.

Thus, the interconnecting device and system easily provide a network building environment irrespective of a location and working time. In addition, the wireless communication between the interconnecting device and the network device would eliminate cable wiring and facilitate construction of the network.

What is claimed is:

1. An interconnecting device configured to be connected to a network and a plurality of network devices, the interconnecting device comprising:
a wireless communication portion comprising a bluetooth compatible module; and
a control portion configured to route a packet among the network devices via the wireless communication portion.

2. The interconnecting device of claim 1, wherein the wireless communication portion further comprises an infrared data association (IrDA) module.

3. The interconnecting device of claim 1, further comprising a housing configured to accommodate the wireless communication portion and the control portion, the housing having a slot, wherein the wireless communication portion comprises an expansion medium for expanding a function of the interconnecting device, and wherein the expansion medium is insertable into the slot in the housing.

4. The interconnecting device of claim 3, wherein the expansion medium is a Personal Handy-phone System card.

5. The interconnecting device of claim 3, wherein the expansion medium is a communication card having the bluetooth compatible module.

6. The interconnecting device of claim 1, further comprising:
a wire communication portion configured to provide communication with at least one of the network devices; and
a storage portion configured to store a routing table for correlating each network device with one of the wireless and wire communication portions.

7. The interconnecting device of claim 1, wherein the wireless communication portion comprises at least one of a transmitter and receiver configured for short range communication.

8. An interconnecting device, configured for connection to a network and a plurality of network devices, the interconnecting device comprising:
a control portion configured to route a packet among the network device; and
a housing for accommodating a wireless communication portion and a control portion, wherein the housing comprises a slot through which an expansion medium for expanding a function of the interconnecting portion is inserted.

9. An interconnecting system, comprising:
a plurality of network devices; and
an interconnecting device configured to connect the plurality of network devices to a network, wherein the interconnecting device comprises:
a wireless communication portion comprising a bluetooth compatible module; and
a control portion configured to route a packet to one of the plurality of network devices via the wireless communication portion.

10. The interconnecting system of claim 9, wherein the plurality of network devices comprises a portable device.

11. The interconnecting system of claim 9, wherein the plurality of network devices comprises a router.

12. The interconnecting system of claim 9, wherein the wireless communication portion comprises at least one of a transmitter and receiver configured for short range communication.

13. An interconnecting system, comprising:
a first network;
a plurality of network devices;
an interconnecting device configured to connect the network devices to the first network, wherein the interconnecting device comprises a wireless communication portion and a control portion, and wherein the control portion is configured to route a packet to one of the plurality of network devices via the wireless communication portion;
a second network connected to the first network; and
a third network, wherein the second network is connected to the first network via the third network.

14. The interconnecting system of claim 13, wherein the second network comprises:
a plurality of other network devices, different from the plurality of network devices of the first network; and
an interconnecting device, wire-connected to the other network devices and the third network, and configured to route a packet among the other network devices of the second network.

15. A method of connecting a plurality of network devices to a network, wherein the plurality of network devices are connected to an interconnecting device and the interconnecting device comprises a wireless communication portion and a wire communication portion, the method comprising:
creating a routing table for correlating each network device with one of the wireless and wire communication portions; and
routing a packet to the network devices using one of the wireless and wire communication portions defined in the routing table.

16. The method of claim 15, wherein creating a routing table uses a Media Access Control address for identification of each network device.

17. The method of claim 15, wherein the plurality of network devices comprises a first and second network device, and wherein the method further comprises performing a predefined process including modulation and demodulation for a packet from the first network device to the second network device, wherein the interconnecting device uses a different one of the wireless and wire communication portions for each of the first and second network devices.

18. The method of claim 15, wherein the wireless communication portion comprises a plurality of wireless communication means, and wherein creating a routing table further comprises identifying one of the wireless communication means or wire communication portion.

19. The method of claim 18, wherein the plurality of network devices comprise a first and a second network device, wherein the method further comprises performing a predefined process including modulation and demodulation for a packet from the first network device to the second network device, and wherein when the interconnecting device uses a different type of wireless communication means for each of the first and second network devices.

20. The method of claim 15, wherein the wireless communication portion is a bluetooth module.

21. An interconnecting device, configured to connect to a first network and a plurality of network devices, the interconnecting device comprising:
a first bluetooth compatible communication device; and
a controller, configured to route a packet from the interconnecting device to at least one of the plurality of network devices via wireless communication using the bluetooth communication device.

22. The interconnecting device of claim 21, further comprising an expansion module, configured to receive a communication medium and to expand the communication capabilities of the interconnecting device.

23. The interconnecting device of claim 22, wherein the communication medium comprises a second bluetooth communication device.

24. The interconnecting device of claim 22, wherein the communication medium is a Personal Handy-phone System card.

25. The interconnecting device of claim 22, wherein the communication medium is configured to provide wireless communication between the interconnecting device and a second network, so as to allow the plurality of network devices to communicate with the second network via the interconnecting device.

26. The interconnecting device of claim 25, wherein the second network is a public network.

27. The interconnecting device of claim 21, further comprising communication ports configured to connect a plurality of network devices to the interconnecting device via a wire connection.

28. The interconnecting device of claim 22, wherein the first bluetooth communication device is a removable medium, and wherein the interconnecting device further comprises a second expansion module configured to receive the first bluetooth communication device.

29. The interconnecting device of claim 21, wherein the control portion is further configured to control a security of the network.

30. The interconnecting device of claim 21, wherein the control portion is further configured to monitor a status of the network devices.
